(19) United States
(12) Patent Application Publication
(10) Pub. No.: US 2022/0335521 A1
(43) Pub. Date: Oct. 20, 2022

(54) OPTIMIZING THE PLANNING OF CONSTRUCTION LOAN INSPECTIONS ON BEHALF OF ONE OR MORE LENDERS

(71) Applicant: Northwest Construction Control, Inc., Summer, WA (US)

(72) Inventors: Charles Manning, Seattle, WA (US); Cathryn Binder, Spanaway, WA (US); Patrick Dunagan, Gig Harbor, WA (US)

(21) Appl. No.: 17/724,289

(22) Filed: Apr. 19, 2022

Related U.S. Application Data
(60) Provisional application No. 63/176,540, filed on Apr. 19, 2021.

(51) Int. Cl. G06Q 40/02; G06Q 10/10

(52) U.S. Cl. CPC G06Q 40/025; G06Q 10/103; G06Q 10/1095

(57) ABSTRACT

A facility for arranging building loan inspections is described. The facility collects building loan inspection requests that originate with lenders during a first period of time. The facility determines an assignment of each received request to one of a plurality of inspectors at a date and time during a second period of time beginning after the end of the first period. The second period has a length no longer than 20% of the length of the first period; the proposed assignment seeking to minimize travel time and inspector dead time of each inspector.

### CROSS-REFERENCE TO RELATED APPLICATION

This application claims the benefit and priority to provisional U.S. Application No. 63/176,540, filed Apr. 19, 2021, the entirety of which is hereby incorporated by reference. In cases where a document incorporated herein by reference conflicts with the present disclosure, the present disclosure controls.

### BACKGROUND

For each construction loan made by a lender, it is typical for the lender to commission multiple onsite inspections. These construction loan inspections are conducted in order to record the project's progress, and either provide recommendations for further funding or reveal irregularities or deviations from the project's plan. Inspection types include (1) initial on-site inspection, to determine the condition of the construction site and to provide a reference point for future progress inspections; (2) draw inspections, to determine that the previously disbursed funds have been used in accordance with the project plan and the budget; and (3) final inspections, to determine that the project is indeed complete and that there is no further work necessary in accordance with the project's plan. Generally, a lender uses the report from each commissioned inspection as a basis for determining whether to release loaned funds to the builder.

Construction loan inspections are generally performed by specialized construction loan inspectors, many of whom operate their own construction loan inspecting businesses. It is common for each construction loan inspection to be arranged individually with a particular inspector in response to communication from the corresponding builder, either directly by the lender or through an intermediary.

### BRIEF DESCRIPTION OF THE DRAWINGS

FIG. 1 is a network diagram showing a sample environment in which the facility operates in some embodiments.

FIG. 2 is a block diagram showing some of the components typically incorporated in at least some of the computer systems and other devices on which the facility operates.

FIG. 3 is a flow diagram showing a process performed by the facility in some embodiments to obtain and maintain information about an inspector.

FIG. 4 is a display diagram showing a sample display presented by the facility in some embodiments in order to solicit inspector information.

FIG. 5 is a display diagram showing a sample display presented by the facility in some embodiments in order to solicit additional inspector information.

FIG. 6 is a display diagram showing a sample display presented by the facility in some embodiments to solicit additional inspector information.

FIG. 7 is display diagram showing a sample display presented by the facility in some embodiments to solicit further inspector information.

FIG. 8 is a table diagram showing sample contents of an inspector table used by the facility in some embodiments to store inspector information.

FIG. 9 is a flow diagram showing a process performed by the facility to arrange construction loan inspections.

FIG. 10 is a display diagram presented by the facility in some embodiments to enable a lender user to submit inspection requests for scheduling by the facility.

FIG. 11 is a table diagram showing sample contents of an inspection table used by the facility in some embodiments to store information about inspections requested by lenders, their scheduling, and their resolution.

FIG. 12 is a sample display presented by the facility in some embodiments to enable an inspector to approve or reject proposed inspection assignments.

FIG. 13 is a sample display diagram presented by the facility in some embodiments to show on a map the project locations of inspections tentatively assigned to a particular inspector.

FIG. 14 is a flow diagram showing a process performed by the facility in some embodiments to conclude a finally assigned inspection.

FIG. 15 is a display diagram showing a sample display presented by the facility in some embodiments to enable an inspector to submit an inspection report for a completed inspection.

FIG. 16 is a flow diagram showing a process performed by the facility in some embodiments to provide administrative views into the operation of the facility.

FIG. 17 is display diagram showing a sample display presented by the facility in some embodiments to show all of the pending inspections in a particular region.

FIG. 18 is a display diagram showing a sample display presented by the facility in some embodiments to show the preferred inspection regions of different inspectors.

FIG. 19 is a display diagram presented by the facility in some embodiments to track the performance of assigned inspections.

### DETAILED DESCRIPTION

The inventors have recognized significant disadvantages of conventional approaches to arranging construction loan inspections. In particular, the period of time between discovering the need for a construction loan inspection and receiving a report for the completed inspection is often long, delaying progress on and ultimately completion of the project. Also, inspectors' time is often used inefficiently, as one-inspection-at-a-time scheduling often results in dead periods and/or long drives between inspections. In cases where an inspector seeks to earn a certain amount per day, this inefficiency is transferred to lenders in the form of high per-inspection inspection fees.

In response to recognizing these disadvantages of conventional techniques for arranging construction loan inspections, the inventors have conceived and reduced to practice a software and/or hardware facility for optimizing the planning of construction loan inspections on behalf of one or more lenders (“the facility”).

The facility registers inspectors, obtaining information in various embodiments about their certifications, other qualifications, and areas and depth of expertise; geographic region of operation; rates; and/or typical availability.

For each of the lenders on behalf of which the facility operates, the facility aggregates the inspection requests that originate with the lender over a period of time, such as one month. Each request includes information helpful in assigning it to an inspector and a time, such as geographic location, inspection type or attributes, etc. In some embodiments, the facility synchronizes these periods, such that they coincide for at least a portion of the lenders. In various embodiments, the facility aggregates inspection requests from multiple lenders on behalf of which the facility operates, or even all such lenders.

When a period ends, the facility constructs a proposed schedule that assigns each request that originated during the period to an inspector and time. In various embodiments, in establishing these proposed assignments, the facility considers a variety of factors for matching inspectors with inspections, such as geographic location, expertise/qualifications, cost, availability, reliability ratings determined by the facility, etc.

In constructing the proposed schedule, the facility seeks to focus performance of inspections for a set of requests that originated over a relatively long period of time—such as a month—into a significantly shorter period of time— such as 2, 3, 4, or 5 days. By consolidating a large number of inspection requests that arise over a long period of time into a short period of time for performance, the facility tends to capture the efforts of the best inspectors for that period for its lender.

This time-consolidation of inspection requests also provides added opportunity for the facility to establish proposed schedules for a number of different inspectors in which each inspector has one or more full working days in which the inspector is efficiently routed among inspection locations, minimizing both travel time and dead time for the inspector. Such per-inspector scheduling maximizes the number of inspections the inspector can perform per day. In cases where the inspector has the objective of earning a certain amount in fees per day, that amount can be distributed across a greater number of inspections, reducing the cost of each inspection. This approach can also lead to many of the inspectors setting aside a certain monthly block of days to service the lenders who use the facility to plan their inspections, which further enhances the facility's ability to generate efficient schedules for them.

The facility presents the proposed schedule it generates for each inspector to the inspector, and prompts the inspector to respond to identify the assigned inspections that the inspector will perform. On the basis of these responses, the facility finalizes accepted assignments, and reassigns rejected assignments.

By operating in some or all of these ways, the facility renders construction loan inspections more time-efficient and cost-efficient, and fosters a positive rapport with good inspectors.

Also, the facility improves the functioning of computer or other hardware, such as by reducing the dynamic display area, processing, storage, and/or data transmission resources needed to perform a certain task, thereby enabling the task to be permitted by less capable, capacious, and/or expensive hardware devices, and/or be performed with lesser latency, and/or preserving more of the conserved resources for use in performing other tasks. For example, by presenting an inspector with a periodic list of proposed inspection assignments, the facility reduces the total processing resources needed to seek the inspector's acceptance of a stream of single proposed assignments that arrive over time.

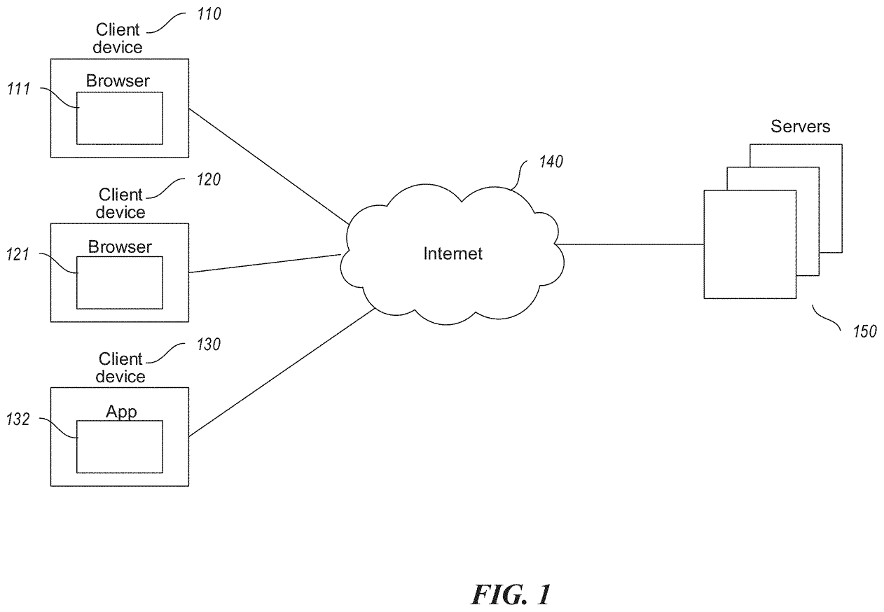

FIG. 1 is a network diagram showing a sample environment in which the facility operates in some embodiments. A number of client devices 110, 120, and 130 are connected via the Internet 140 or another network to one or more servers 150 that operate an inspection arrangement platform. Some of the client devices—such as client device 110—execute a browser that interacts with the platform software on the server on behalf of a lender user, an inspector, or an administrative user for the facility using the client device, while other client devices—such as client device 130—execute a specialized mobile app or desktop application that interacts with the platform software on the server on behalf of a lender user, an inspector, or an administrative user for the facility using the client device.

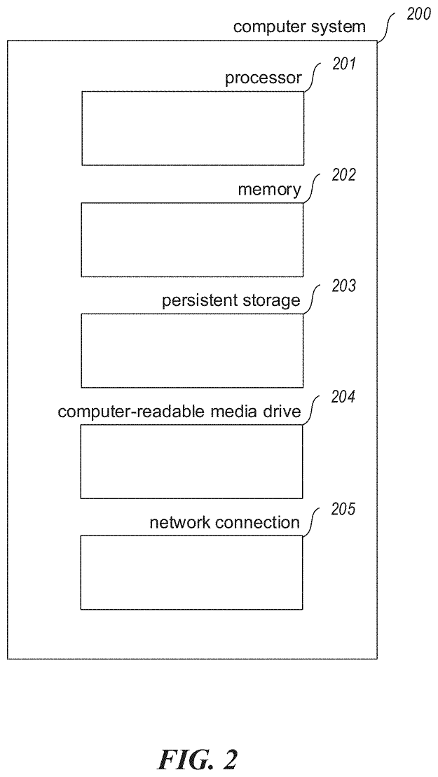

FIG. 2 is a block diagram showing some of the components typically incorporated in at least some of the computer systems and other devices on which the facility operates, including the devices shown in FIG. 1. In various embodiments, these computer systems and other devices 100 can include server computer systems, cloud computing platforms or virtual machines in other configurations, desktop computer systems, laptop computer systems, netbooks, mobile phones, personal digital assistants, televisions, cameras, automobile computers, electronic media players, etc. In various embodiments, the computer systems and devices include zero or more of each of the following: a processor 101 for executing computer programs and/or training or applying machine learning models, such as a CPU, GPU, TPU, NNP, FPGA, or ASIC; a computer memory 102 for storing programs and data while they are being used, including the facility and associated data, an operating system including a kernel, and device drivers; a persistent storage device 103, such as a hard drive or flash drive for persistently storing programs and data; a computer-readable media drive 104, such as a floppy, CD-ROM, or DVD drive, for reading programs and data stored on a computer-readable medium; and a network connection 105 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. While computer systems configured as described above are typically used to support the operation of the facility, those skilled in the art will appreciate that the facility may be implemented using devices of various types and configurations, and having various components.

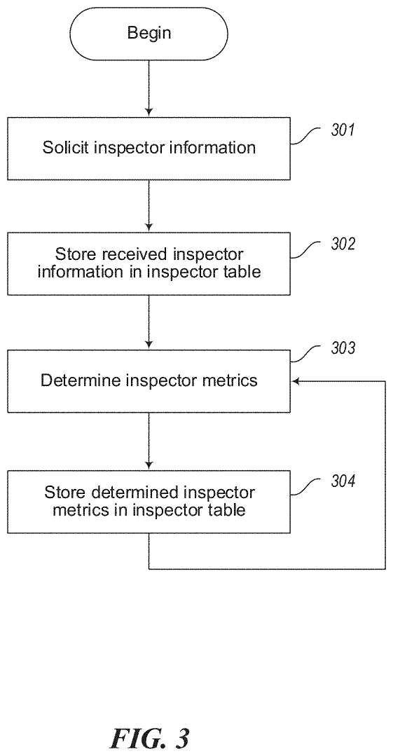

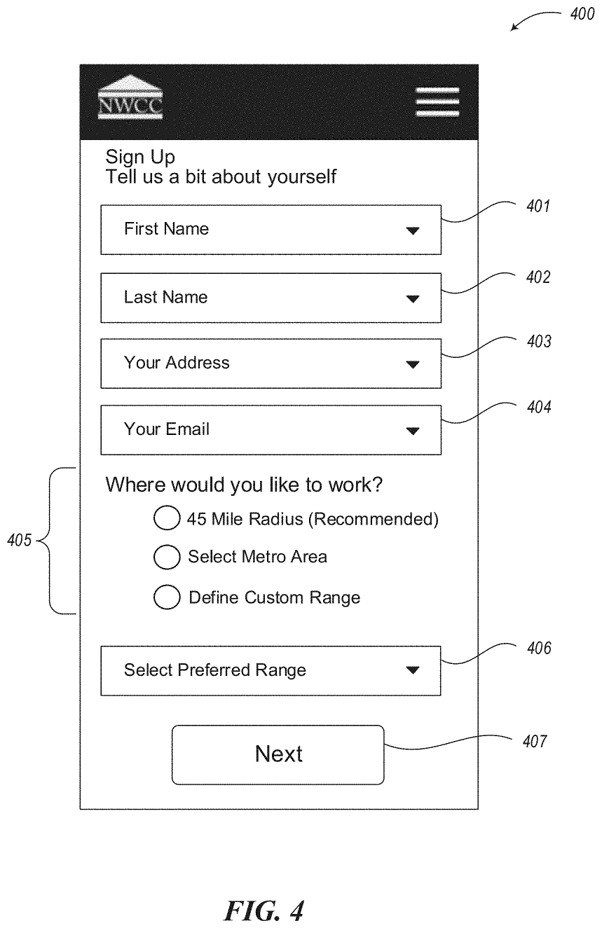

FIG. 3 is a flow diagram showing a process performed by the facility in some embodiments to obtain and maintain information about an inspector. In act 301, the facility solicits information from the inspector. FIGS. 4-7 show examples of the solicitation of information from an inspector.

FIG. 4 is a display diagram showing a sample display presented by the facility in some embodiments to begin soliciting inspector information. The display 400 includes a control 401 for specifying the inspector's first name; a control 402 for specifying the inspector's last name; a control 403 for specifying the inspector's postal address; and a control 404 for specifying the inspector's email address. The display also includes controls 405 and 406 for specifying a geographical area in which the inspector prefers to work. The display further includes a next control 407 for advancing to a successive page of the user interface.

While FIG. 4 and each of the display diagrams discussed below show a display whose formatting, organization, informational density, etc., is best suited to certain types of display devices, those skilled in the art will appreciate that actual displays presented by the facility may differ from those shown, in that they may be optimized for particular other display devices, or have shown visual elements omitted, visual elements not shown included, visual elements reorganized, reformatted, or shown at different levels of magnification, etc.

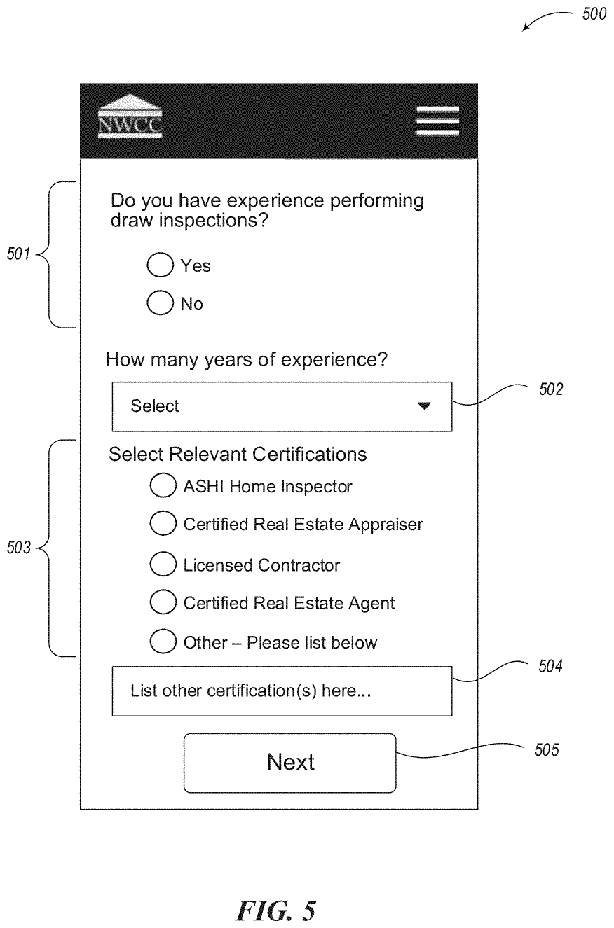

FIG. 5 is a display diagram showing a sample display presented by the facility in some embodiments in order to solicit additional inspector information. In some embodiments, the facility presents display 500 shown here in response to the user's activation of the next control 407 shown in FIG. 4. Controls 501 and 502 permit the inspector to specify their level of experience performing construction loan inspections. Controls 503 and 504 can be used to specify the inspector's relevant certifications. Next control 505 can be used to advance to the next page of the user interface.

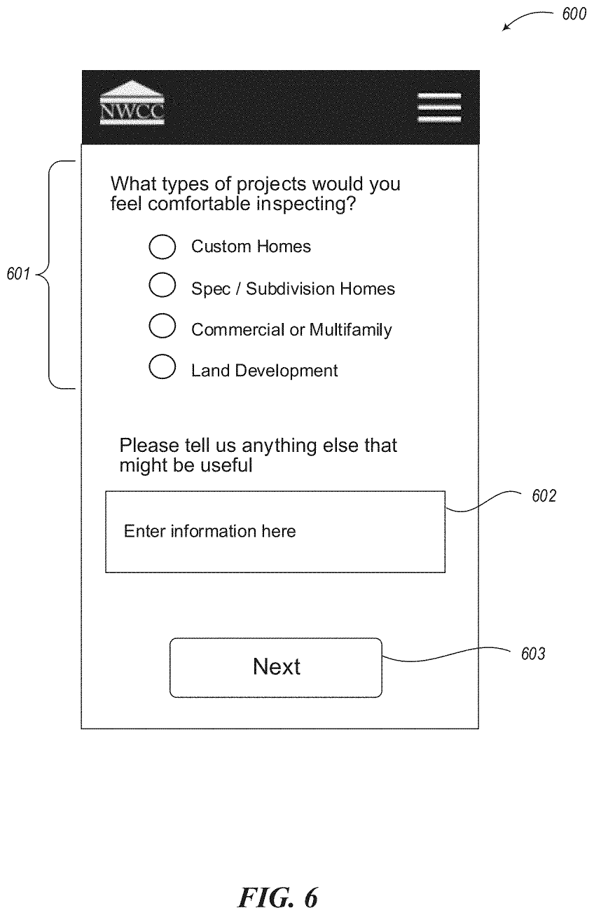

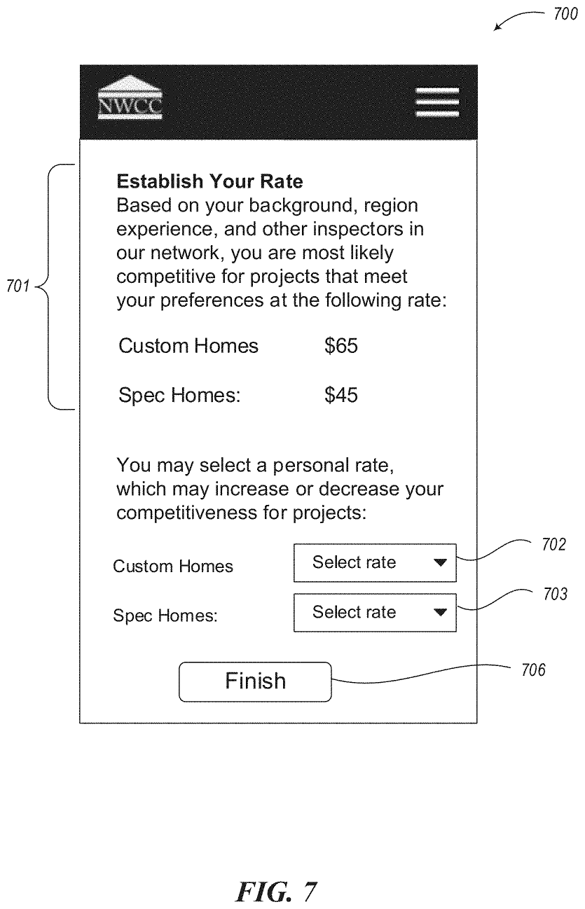

FIG. 6 is a display diagram showing a sample display presented by the facility in some embodiments to solicit additional inspector information. In some embodiments, the facility presents this display 600 in response to the user's activation of next control 505 shown in FIG. 5. The display includes a control 601 for expressing the inspector's preferences about project types, and control 602 for providing additional information that may be relevant to the inspector's assignment to inspections or their scheduling. The display also includes a next control 603 that can be activated to advance to the next page of this user interface. FIG. 7 is display diagram showing a sample display presented by the facility in some embodiments to solicit further inspector information. In some embodiments, the facility presents this display 700 in response to the user's activation of next control 603 shown in FIG. 6. The display includes information 701 about typical inspecting rates, as well as controls 702 and 703 for specifying the inspector's inspection rate for custom homes, and spec homes, respectively. The display also includes a finish control 704 to conclude the process of providing inspector information for this inspector.

Returning to FIG. 3, in act 302, the facility stores the inspector information received in act 301 in an inspector table.

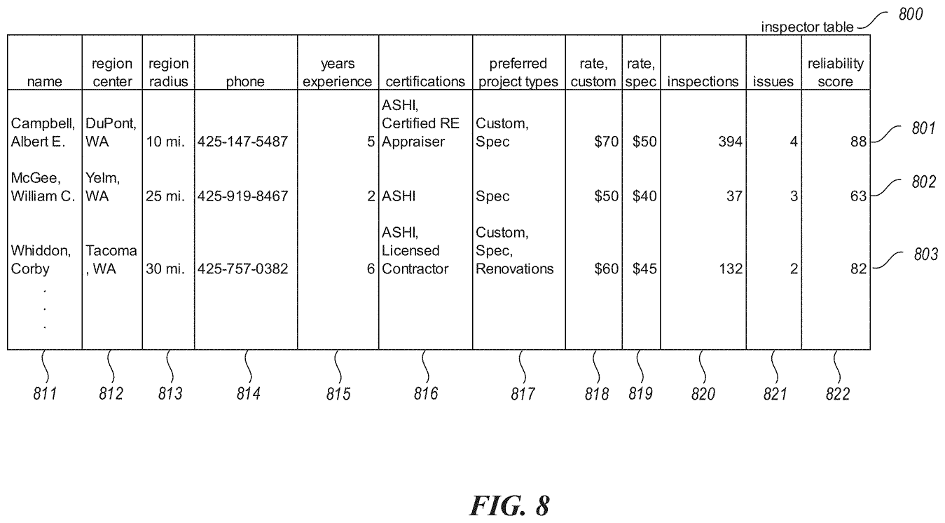

FIG. 8 is a table diagram showing sample contents of an inspector table used by the facility in some embodiments to store inspector information. The inspector table 800 is made up of rows, such as rows 801-803, each corresponding to a different inspector who is registered with the facility. Each of the rows is divided into the following columns: a name column 811 contain the inspector's name; a region center column 812 specifying a geographic point that is at or near the region in which the inspector operates; a region radius column 813 containing a distance that is a radius of a region surrounding the region center in which the inspector operates; a phone column 814 containing the inspector's phone number; a years of experience column 815 indicating the number of years for which the inspector has been performing construction loan inspections; a certifications column 816 indicating certifications held by the inspector; a preferred project types column 817 indicating the kinds of construction projects the inspector prefers to inspect; a rate for custom homes column 818 showing the rate charged by the inspector to inspect custom homes; a rate for spec homes column 819 showing the inspector's rate for inspecting spec homes; an inspections column 820 showing the number of inspections assigned by the facility to the inspector and accepted by the inspector; an issues column 821 indicating the number of those inspections with which issues have been identified; and a reliability score column 822 indicating a score calculated by the facility for the inspector that indicates the inspector's reliability. For example, row 803 indicates that an inspector Corby Whiddon inspects in a region having Tacoma, Wash., at its center and a 30 mile radius; has the phone number 425-757-0382; has performed construction loan inspections for six years; has the certifications “ASHA” and “Licensed Contractor”; prefers to inspect custom, spec, and renovation project types; charges $60 for custom home inspections and $45 for spec home inspections; has accepted 132 inspection assignments from the facility, two of which have had issues; and has a reliability score of 82.

While FIG. 8 and each of the table diagrams discussed below show a table whose contents and organization are designed to make them more comprehensible by a human reader, those skilled in the art will appreciate that actual data structures used by the facility to store this information may differ from the table shown, in that they, for example, may be organized in a different manner; may contain more or less information than shown; may be compressed, encrypted, and/or indexed; may contain a much larger number of rows than shown, etc.

Returning to FIG. 3, in act 303, the facility determines inspector metrics based upon their inspection activities. In act 304, the facility stores or updates the inspector metrics determined in act 303 in the inspector table. After act 304, the facility continues in act 303 at a future time to determine additional or updated inspector metrics.

Those skilled in the art will appreciate that the acts shown in FIG. 3 and in each of the flow diagrams discussed below may be altered in a variety of ways. For example, the order of the acts may be rearranged; some acts may be performed in parallel; shown acts may be omitted, or other acts may be included; a shown act may be divided into subacts, or multiple shown acts may be combined into a single act, etc.

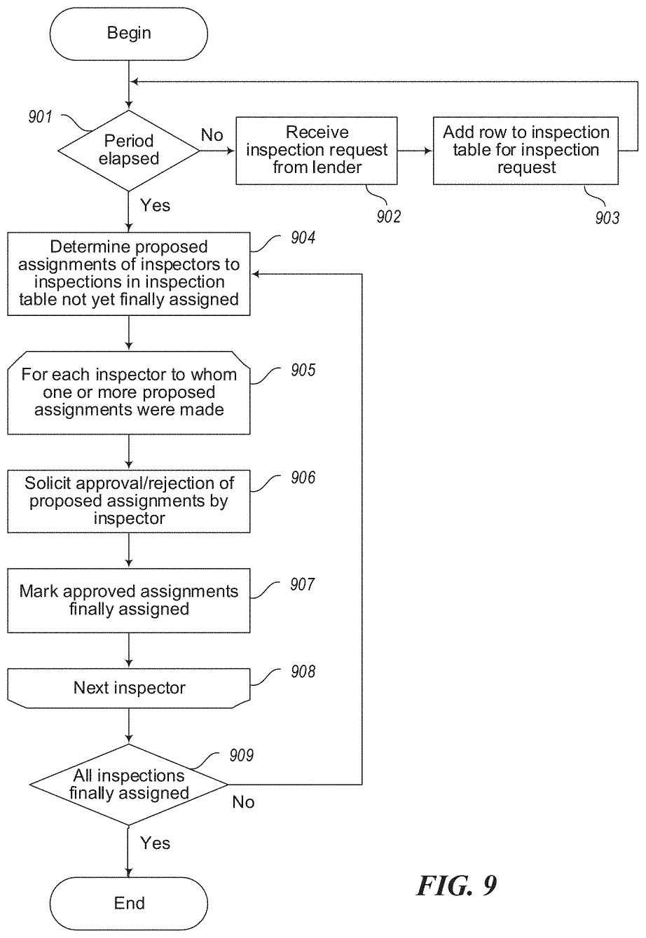

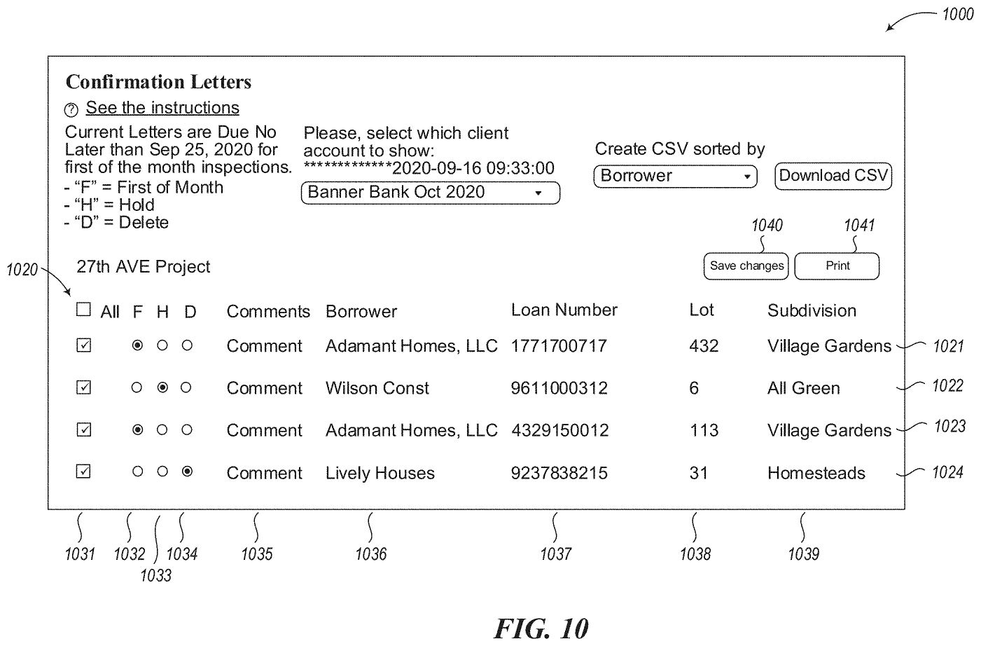

FIG. 9 is a flow diagram showing a process performed by the facility to arrange construction loan inspections. In act 901, if the period for which the facility batches inspection requests—such as a month—has expired, then the facility continues in act 904, else the facility continues in act 902. In act 902, the facility receives an inspection request from a lender. An example showing the generation of inspection requests by a lender is shown in FIG. 10 and discussed below.

FIG. 10 is a display diagram presented by the facility in some embodiments to enable a lender user to submit inspection requests for scheduling by the facility. The display 1000 is a table 1020 of construction loans of a particular lender for which the lender has received a disbursement request from the contractor. For example, rows 1021-1024 each correspond to such a loan. The table contains information identifying each loan, such as in a borrower name column 1036, a loan number column 1037, a lot number column 1038, and a subdivision name column 1039. The table also includes a comment column 1035, which can, for example, contain information about the status of the project, the nature of the disbursement that was requested, etc. The table also contains controls in columns 1032-1034 that can be used by the lender user to specify whether each loan is selected for inspection in the next inspection cycle. In cases where the lender user wants to schedule a loan for inspection, such as the loans shown rows 1021 and 1023, the user selects a schedule control 1032. For loans, such as the loan shown in row 1022 where the user wishes to hold the loan for inclusion in a future inspection cycle, the user selects a pulled control 1033. And for loans like the loan to which row 1024 corresponds where the user wants to delete the loan from consideration for inspection, the user selects delete control 1034. In some embodiments, the facility initials controls 1032-1034 to the same instruction for each loan, such as the hold instruction, or the select for inspection instruction. In some embodiments, the user can use a row selection column 1031 in order to efficiently mark all or a large number of the rows with the same instruction. The display also includes a control 1040 that the user can activate in order to store the instructions specified in the controls for processing by the facility. The display also includes a control 1041 that the user can activate in order to print the contents of the display.

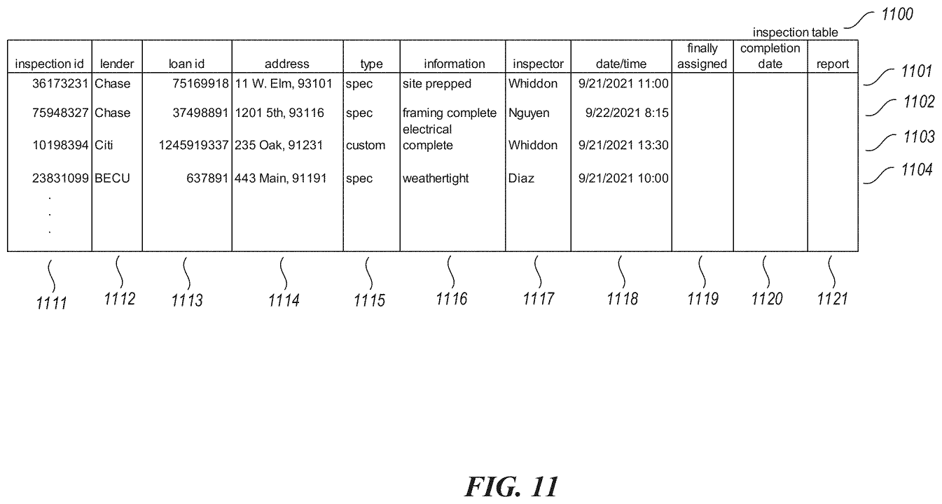

Returning to FIG. 9, the facility adds a row to an inspection table for the inspection request received in act 902. The inspection table is shown in FIG. 11 and discussed below.

FIG. 11 is a table diagram showing sample contents of an inspection table used by the facility in some embodiments to store information about inspections requested by lenders, their scheduling, and their resolution. The inspection table 1100 is made up of rows, such as rows 1101-1104, each corresponding to an inspection requested by a lender. Each row is divided into the following columns: an inspection id column 1111 containing an identifier assigned by the facility to the inspection to uniquely identify it; a lender column 1112 containing the name of the lender requesting the inspection; a loan id column 1113 containing an identifier assigned by the lender to identify the loan; an address column 1114 containing the street address at which the construction project to be inspected is occurring; a type column 1115 identifying the type of the project; an information column 1116 containing information useful in assigning and/or performing the inspection, such as the status of the project, the nature of the disbursement requested, etc.; an inspector column 1117 identifying an inspector tentatively or finally assigned to the inspection, as discussed further below; a scheduled date/time column 1118 identifying the date and time at which the inspection is to be performed; a finally assigned column 1119 indicating whether any assignment of the inspection to an inspector is final, i.e., has been accepted by the assigned inspector; a completion date column 1120 identifying the date on which the inspection was completed, if it has been completed; and a report column 1121 containing a report or a reference to a report provided by the inspector documenting the inspection and the inspector's conclusions. For example, row 1101 indicates that an inspection having inspection id 36173231 for the lender Chase who assigned it a loan id of 75169918, for a project occurring at 11 W. Elm in the 93101 zip code of the spec type is in a state where the site has been prepped for the project, and an inspector Whiddon has tentatively been assigned to perform the inspection on Sep. 21, 2021, at 11:00 am, this assignment is not yet final, the inspection has not been completed, and no report is yet available.

Returning to FIG. 9, after act 903, the facility continues in act 901. At the time at which the inspection assignment period elapses, the facility continues in act 904. In act 904, the facility determines proposed assignments of inspectors to inspections listed in the inspection table that are not yet finally assigned. These proposed assignments determined by the facility in act 904 include a date and time. Determining the proposed assignments includes matching information collected from and about inspectors to requirements or preferences of each inspection. In determining the assignments, the facility further considers how to make the most efficient use of each inspector during a continuous period of time, such as part of a day, a whole day, a block of two or more days, etc. The facility pursues efficiency both in minimizing dead time and travel time for each inspector. The inspection table 1100 shown in FIG. 11 contains proposed inspector and date/time assignments for sample requested inspections.

In some embodiments, the facility performs act 904 as follows:

First, the facility determines which inspectors are possible matches based on the binary criteria such as the following:
Is the inspector available? (vs. on vacation, sick, etc)
Is the inspector qualified? (this is often most relevant for large/complex commercial projects)
Is the inspector within feasible range? (a configurable distance, such as 50 miles, or 45 minutes of travel time)

Second, for each project, the facility “scores” each inspector who is determined to be available, based on factors such as the following:
Proximity (in terms of distance or travel time)
Reliability (a function of total prior mistakes or errors and total prior projects performed)
Responsiveness, which considers:
   Average time (in business day hours) from being assigned a project to accepting the project
   Average time (in business day hours) from accepting a project to completing a project
Cost (based on each inspectors' negotiated rate per project type)
   The total score for each combination of inspector and project is largely function of weightings attributed to each of the above categories. In some embodiments, the facility permits each lender to configure this weighting for scoring inspectors for its inspections. A first lender who is most concerned with cost and speed can weight these factors heavily, such as by weighting the proximity factor at 30%, the cost factor at 40%, and the reliability and responsiveness factors each at 15%. A second lender who cares most about quality and certainty of execution can weight reliability highest, such as by weighting reliability at 30%, responsiveness at 40%, and proximity and cost both at 15%.

In some embodiments, the facility adjusts each inspector's scores, based upon information such as the following:
If the top X ranked inspectors for a given project are also in the top X ranked projects for another project, they receive a score increase.
This “score increase” degrades as a function of drive time between projects.
   Note that this step intentionally creates a bit of a winner-take-all dynamic, whereby highly ranked inspectors are likely to get more work—especially if that work is in close proximity.

Finally, in some embodiments, the facility ensures that no inspector is assigned an inappropriate number of projects based on their capacity. Inspectors receive those projects for which they most highly rated first, and excessive work is then reassigned again using the above system, except this time excluding those inspectors who have reached maximum capacity. In some embodiments, the facility attributes capacity weights that differ by project types, such as assigning high capacity weights to commercial projects, and lower capacity weights to subdivision projects.

In acts 905-908, the facility loops through each inspector to whom one or more proposed assignments were made in act 904. In act 906, the facility solicits the inspector's approval or rejection of the proposed assignments made to the inspector.

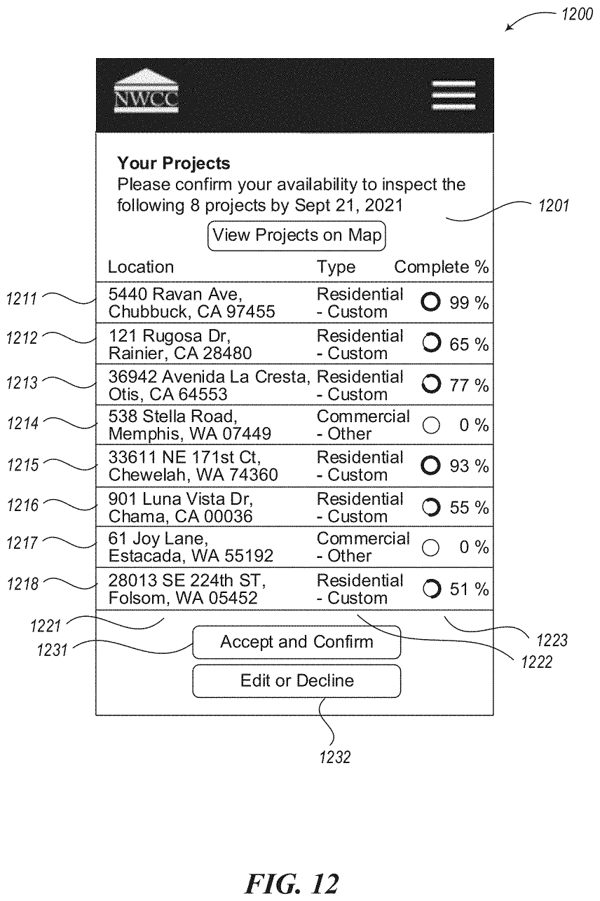

FIG. 12 is a sample display presented by the facility in some embodiments to enable an inspector to approve or reject proposed inspection assignments. The display 1200 includes a list of proposed inspection assignments 1211-1218. For each of these, the display includes the project location 1221, the project type 1222, the an indication 1223 of the extent to which the project is complete. The inspector can activate control 1231 in order to accept all of the proposed assignments, or activate control 1232 in order to either decline all of the proposed assignments, or accept some of the proposed assignments and decline the rest. The inspector can activate 1201 in order to view the projects that are the subject of the proposed assignments on a map.

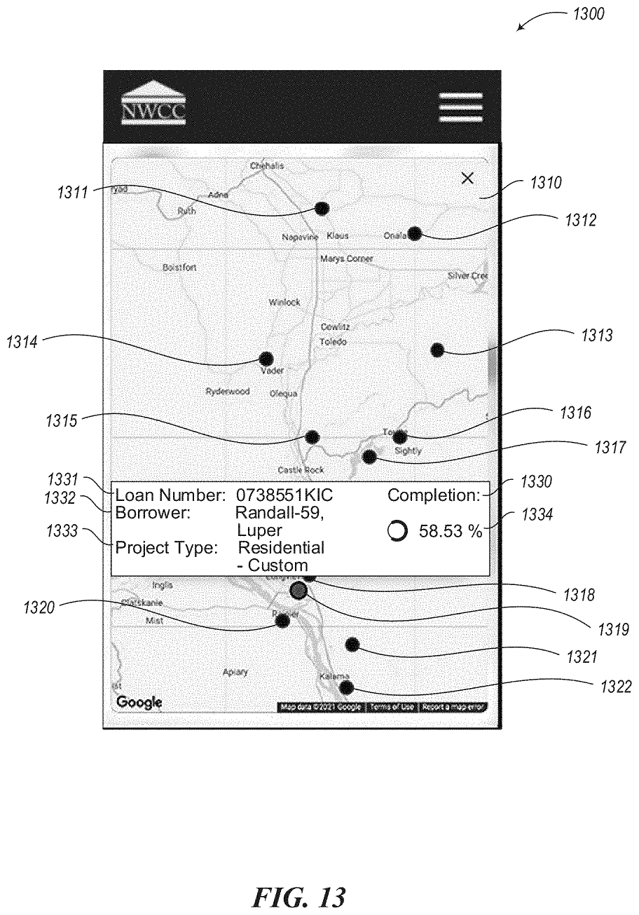

FIG. 13 is a sample display diagram presented by the facility in some embodiments to show on a map the project locations of inspections tentatively assigned to a particular inspector. The display 1300 contains a map 1310 on which project locations 1311-1322 are shown as circles. The inspector can select one of the circles, such as project location 1319, to display information 1330 about the project, including loan number 1331, borrower 1332, project type 1333, and extent of completion 1334.

Referring to FIG. 9, in act 907, the facility marks the assignments approved by the inspector in act 906 as finally assigned in column 1119 of inspection table 1100. In act 908, if additional inspectors remain to be processed, then the facility continues in act 905 to process the next inspector, else the facility continues in act 909. In act 909, if all requested inspections have been finally assigned, then this process concludes, else the facility continues in act 904 to reassign the inspections not finally assigned.

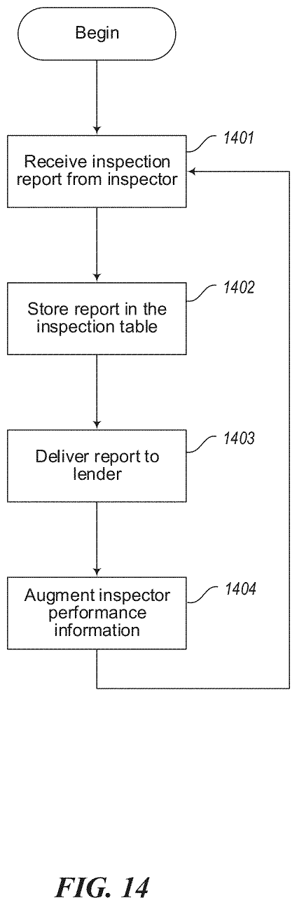

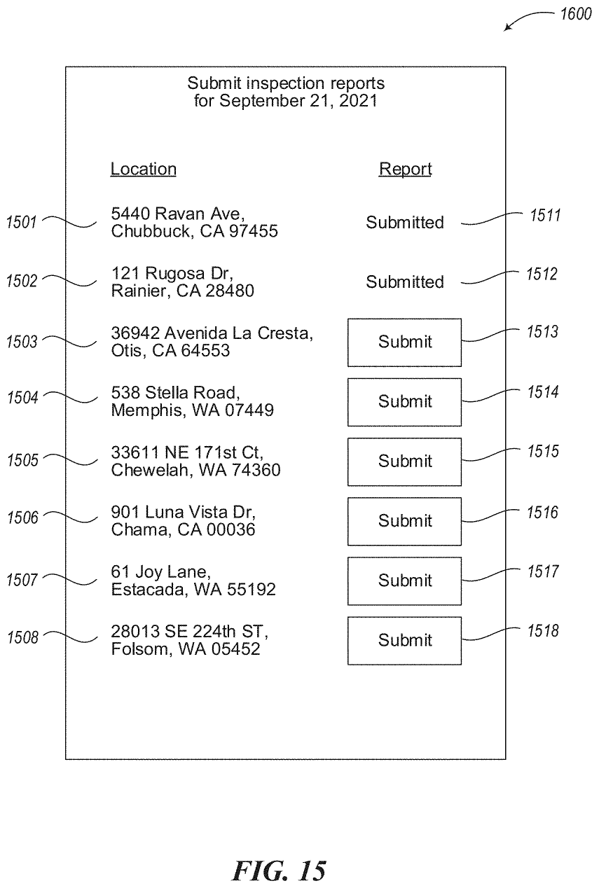

FIG. 14 is a flow diagram showing a process performed by the facility in some embodiments to conclude a finally assigned inspection. In act 1401, the facility receives an inspection report from the assigned inspector. This process is further shown in FIG. 15 discussed below.

FIG. 15 is a display diagram showing a sample display presented by the facility in some embodiments to enable an inspector to submit an inspection report for a completed inspection. The display 1500 includes a list 1501-1508 of the inspections assigned to the inspector. The display further includes indications 1511 and 1512 that the inspector has already submitted inspection reports for assignments 1501 and 1502, respectively. The display further includes controls 1513-1518 that the inspector can activate to submit a report for any of inspections 1503-1508, respectively. In various embodiments, activation of this control permits the inspector to navigate to an already-prepared report file; interact with a further user interface presented by the facility for generating a report; etc.

Returning to FIG. 14, in act 1402, the facility stores the report received in act 1401 in row 1121 of inspection table 1100, either by (a) storing the actual contents of the report in this column of the inspection table, or by (b) storing the contents of the report elsewhere, and storing a reference to this stored copy of the report in the inspection table. In some embodiments (not shown), the facility also stores the date on which the report was received from the inspector in the completion date column 1120 of the inspection table. In act 1403, the facility delivers the report to the lender. In various embodiments, the facility emails the report to the lender; makes the report available for retrieval by the lender using a user interface provided by the facility; stores the report in a shared cloud repository accessible by the lender, etc. In act 1404, the facility augments the inspector performance information, such as to increase the number of inspections performed, adjust scores calculated by the facility for the inspector, etc. After act 1404, the facility continues in act 1401 to receive an additional inspection report from an inspector.

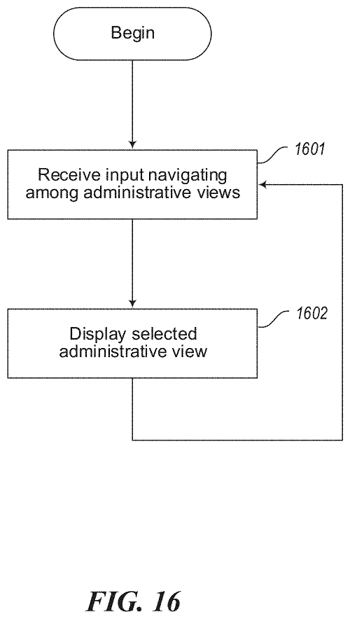

FIG. 16 is a flow diagram showing a process performed by the facility in some embodiments to provide administrative views into the operation of the facility. In act 1601, the facility receives input from an administrative user navigating among administrative views of the facility's operation. In act 1602, the facility displays the administrative view selected in 1601. After act 1602, the facility continues in act 1601 to receive additional navigational input.

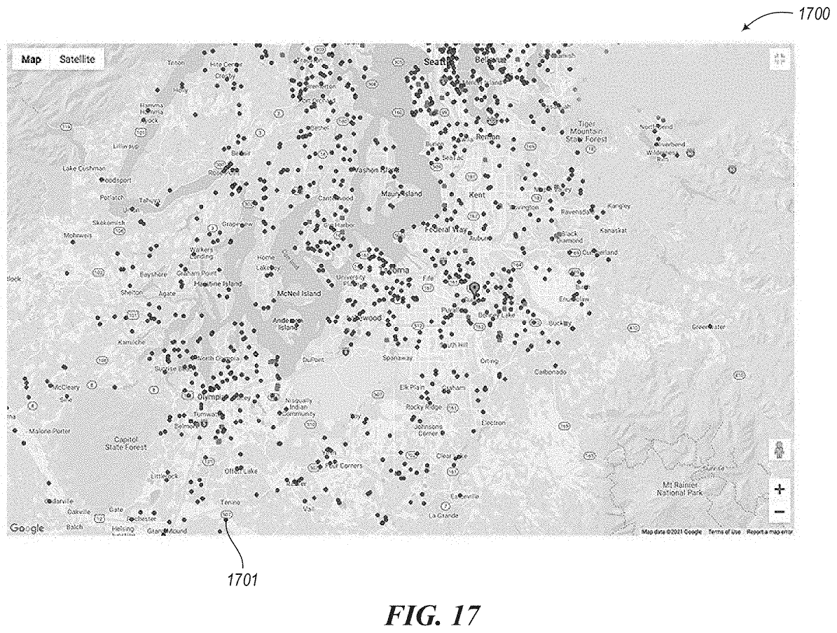

FIG. 17 is display diagram showing a sample display presented by the facility in some embodiments to show all of the pending inspections in a particular region. The entire display 1700 is a map, on which pending inspections are shown as circles, such as pending inspection 1701.

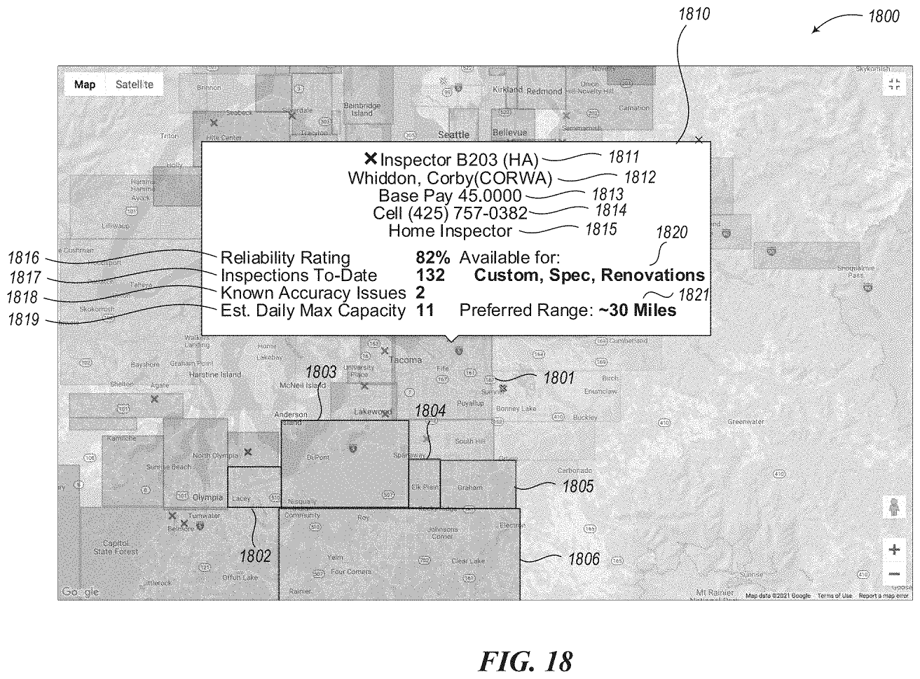

FIG. 18 is a display diagram showing a sample display presented by the facility in some embodiments to show the preferred inspection regions of different inspectors. The entire display 1800 is a map, on which is shown inspection regions 1801-1806 of particular inspectors. The user can select one of these regions in order to display information about the corresponding inspector. For example, here, the user has selected region 1801, causing the facility to display window 1810 containing information about a particular inspector who inspects in this region. As shown, the information displayed is an inspector number 1811, name 1812, inspection rate for spec homes 1813, mobile phone number 1814, professional title 1815, reliability rating 1816, total number of inspections 1817, number of known accuracy issues 1818, estimated daily maximum inspection capacity 1819, project type preferences 1820, and preferred range 1821.

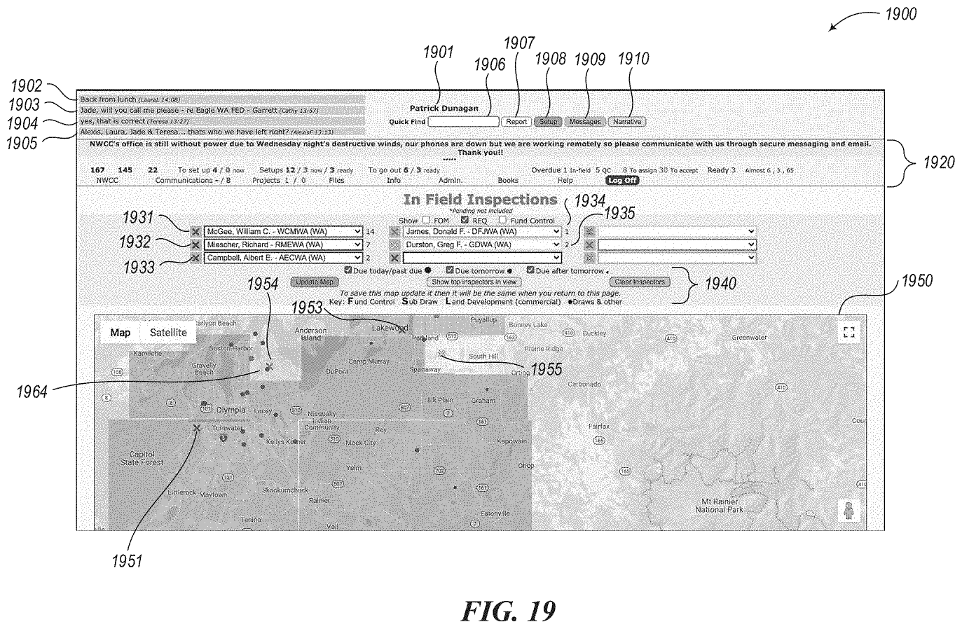

FIG. 19 is a display diagram presented by the facility in some embodiments to track the performance of assigned inspections. The display 1900 includes an indication 1901 of an administrative user for which the facility generated the display. The display also includes a history of messages 1902-1905 exchanged with inspectors. The display further includes a search field 1906; a report control 1907 for generating a report about inspection performance; a setup control 1908 for performing setup functions; a messages control 1909 to display a more comprehensive list of exchanged messages, and exchange messages; and a narrative control 1910. The display further includes statistics 1920 about the inspections being performed. The display further includes indications 1931-1935 identifying five different inspectors to whom inspections are presently assigned. Each indication includes a number of inspections to be performed, e.g., 14 inspections for inspector McGee. Each indication contains a downward-pointing caret that the user may click on in order to select an inspector from a dropdown menu to show an indication. Each indication further has a colored “x” on its left end that enables a user to correlate a similarly-colored “x” in map 1950 indicating the present or recent location of this inspector. For example, location indicator 1951 identifies on the map the location of inspector 1931. Similarly, location indication 1953 identifies the location of inspector 1933, location indicator 1954 identifies the location of inspector 1934, and location indicator 1955 identifies the location of inspector 1935. In some embodiments, each inspector gives permission to a mobile app running on a device carried by the inspector, such as a smartphone, to report the device's GPS location for use by the facility in support of displaying these location indicators. The map also shows inspections to be performed by each inspector as a round dot on the map in the same color; for example, inspection indicator 1964 identifies an inspection to be performed by inspector 1934. The display also includes additional controls 1940 for reconfiguring the display in the map in various ways.

It will be apparent to those skilled in the art that the facility and its operation can be straight forwardly extended to other types of inspections—such as home purchase inspections, electrical inspections, permitting inspections, etc.—as well as other services, such as real estate appraisal.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method in a computing system for arranging building loan inspections, comprising:
for a first period of time, collecting building loan inspection requests originating with lenders, each request identifying a loan, a geographic location of a construction project being performed with the loan, and inspection directions;
accessing a list of building loan inspectors;
during a second period of time beginning after the end of the first period, repeating until inspections have been finally scheduled for all of the requests received during the first period:
automatically determining a proposed assignment of each received request not yet finally scheduled to an inspector in the list at a date and time during a third period of time beginning after the end of the second period, the third period having a length no longer than 25% of a length of the first period, the proposed assignment seeking to minimize inspector travel time and inspector dead time;
for each inspector in the list who is the object of at least one proposed assignment:
presenting the proposed assignments to the inspector;
receiving input from the inspector approving or declining each proposed assignment;
finalizing each approved assignment;
during the third period:
for each finalized assignment:
directing the assigned inspector to the assignment;
receiving from the assigned inspector an inspection report reporting on performance of the assignment; and
making the received inspection report available to the lender with which the corresponding request originated.

2. The method of claim 1 wherein the determining further seeks to minimize total inspection fees and/or maximize the extent to which highly-rated inspectors are utilized.

3. The method of claim 1 wherein each inspector in the list has specified a preferred inspection region,
and wherein the determining further seeks to maximize the extent to which proposed assignments are made to inspectors whose preferred inspection regions contain the geographic location of the corresponding construction project.

4. The method of claim 1 wherein the determining further seeks to maximize the extent to which proposed assignments are made to inspectors that satisfy inspector requirements specified as part of the requests.

5. The method of claim 1, further comprising presenting that administrative user interface in which performance of assignments by inspectors is tracked.

6. The method of claim 1 wherein the length of the third period is no longer than 10% of the length of the first period.

7. One or more instances of computer-readable media collectively having contents configured to cause a computing system to perform a method for arranging building loan inspections, the method comprising:
collecting building loan inspection requests originating with lenders during a first period of time;
automatically determining an assignment of each received request to one of a plurality of inspectors at a date and time during a second period of time beginning after the end of the first period, the second period having a length no longer than 20% of a length of the first period, the proposed assignment seeking to minimize travel time and inspector dead time of each inspector;
for each assignment:
directing the assigned inspector to the assignment;
receiving from the assigned inspector an inspection report reporting on performance of the assignment; and
making the received inspection report available to the lender with which the corresponding request originated.

8. The one or more instances of computer-readable media of claim 7, the determining an assignment comprising:
for each received request:
for each inspector among the plurality:
determining whether the inspector is available for the request;
if the inspector is determined to be available for the request, determining a score for the suitedness of the inspector to the request, the score reflecting the inspector's proximity, reliability, responsiveness, and cost; and
assigning the request to the inspector for whom the highest score was determined.

9. The one or more instances of computer-readable media of claim 8, further comprising:
for each received request:
retrieving relative weighting levels specified by the lender with which the request originated for the proximity, reliability, responsiveness, and cost factors,
and wherein each score determined for a request is determined in accordance with the relative weighting levels retrieved for the request.

10. The one or more instances of computer-readable media of claim 7 wherein the determining further seeks to minimize total inspection fees and/or maximize the extent to which highly-rated inspectors are utilized.

11. The one or more instances of computer-readable media of claim 7 wherein each inspector in the list has specified a preferred inspection region,
and wherein the determining further seeks to maximize the extent to which proposed assignments are made to inspectors whose preferred inspection regions contain the geographic location of the corresponding construction project.

12. The one or more instances of computer-readable media of claim 7 wherein the determining further seeks to maximize the extent to which proposed assignments are made to inspectors that satisfy inspector requirements specified as part of the requests.

13. The one or more instances of computer-readable media of claim 7, the method further comprising presenting an administrative user interface in which performance of assignments by inspectors is tracked.

14. The one or more instances of computer-readable media of claim 7 wherein the length of the third period is no longer than 10% of the length of the first period.

15. The one or more instances of computer-readable media of claim 7, the method further comprising:
for each inspector who is the object of at least one proposed assignment:
presenting the assignments to the inspector;
receiving input from the inspector approving or declining each proposed assignment; and
for each assignment declined by the inspector, repeating the determining.

16. One or more memories collectively storing a construction loan inspection schedule data structure, the data structure comprising:
a plurality of entries, each entry representing one of a plurality of inspection requests each originated by lender during a first period of time, each entry comprising:
information identifying an inspector assigned to the inspection request; and
information indicating a date and time for which the inspection request has been scheduled,
the dates and times indicated by all of the entries falling within a second period of time that follows the first period, the second period having a length less than or equal to 25% of a length of the first period,
such that the contents of the data structure are usable to perform the inspection requests of the plurality.

17. The one or more memories of claim 16 wherein the length of the second period is less than or equal to 15% of the length of the first period.

18. The one or more memories of claim 16 wherein each inspection request specifies a geographic location,
and wherein the assignment of inspectors to inspection requests and the dates and times when they are scheduled seeks to minimize inspector travel times among assigned inspection request geographic locations.

19. The one or more memories of claim 16 wherein the assignment of inspectors to inspection requests and their scheduled dates and times seeks to minimize inspector dead times between assigned inspection requests.

20. The one or more memories of claim 16 wherein the assignment of inspectors to inspection requests and their scheduled dates and times seeks to minimize total inspection fees and/or maximize the extent to which highly-rated inspectors are utilized.

21. The one or more memories of claim 16 wherein the assignment of inspectors to inspection requests seeks to maximize the extent to which assignments are made to inspectors having preferred inspection regions that contain the geographic location of the corresponding construction project.
